(19) United States
(12) Patent Application Publication
(10) Pub. No.: US 2004/0115448 A1
(43) Pub. Date: Jun. 17, 2004

(54) Corrosion resistant magnesium and magnesium alloy and method of producing same

(76) Inventor: John W. Bibber, Batavia, IL (US)

Correspondence Address: Robert F. I. Conte, LEE, MANN, SMITH, McWILLIAMS,, SWEENEY & OHLSON, P.O. Box 2786, Chicago, IL, 60690-2786, US

(21) Appl. No.: 10/325,554

(22) Filed: Dec. 17, 2002

(51) Int. Cl. B32B 15/04

(52) U.S. Cl. 428/471

(57) ABSTRACT

A non-chromium based magnesium conversion coating composition for coating magnesium or a magnesium alloy articles, which has as the essential ingredients, an alkali metal permanganate and a PH of 2.5 to 4.0. The composition is effective in protecting magnesium and magnesium alloys articles for more than 200 hours of a neutral salt-fog at 95° F. according to ASTM standard method B-117. When the coated magnesium or a magnesium alloy articles are primed with a paint and the painted articles are exposed to the salt-fog there are show no signs of blistering visible to the naked eye. The process of coating the magnesium or magnesium alloy articles is generally carried out by cleaning the magnesium or magnesium alloy articles with a mild alkaline cleaner followed by treatment in a mild acid solution to remove unwanted metal oxides or hydroxides and then conversion coating with the permanganate salt composition at PH of from 2.5 to 4.0.

### FIELD OF INVENTION

This invention relates to a method of coating and to the coated magnesium metal and/or magnesium alloy articles that are coated a permanganate composition to provide the magnesium articles with paint adhesion.

### BACKGROUND OF THE INVENTION

Magnesium and magnesium alloys have been made corrosion resistant by increasing the thickness of the natural oxide films present on the pure metal and / or its alloys by heating the metal, or alloy, in a concentrated alkali metal hydroxide under pressure or by making the metal, or its alloys, the anode in electrolytic cells of various compositions. These conversion coating processes do little more then prevent the tarnishing of the metal and will not provide protection against aggressive environments or provide for good paint adhesion as they are soft and powder like in composition and alkaline in nature. Paint adhesion and under film corrosion resistance is generally provided for by the use of a chromate or dichromate composition (“Operations in Magnesium Finishing”, Dow Chemical Company publication, 1982) and there are a number of such products on the market. Chromate, or hexavalent chromium compositions, are known toxic materials and are being replaced in the market place. This invention provides for an environmentally acceptable alternative to chromate compositions used on magnesium and/or its alloys and provide corrosion resistance and/or paint adhesion.

### SUMMARY OF THE INVENTION

My invention eliminates some of the problems associated with the use of hexavalent chromium and related heavy metal compositions by providing magnesium and magnesium alloys with a non-chromium, permanganate based conversion coating composition containing alkali metal permanganate at a PH of 2.5 to 4.0. One feature of the present invention provides a composition wherein there is at least 0.760 grams of permanganate ion per liter.

Another feature of this invention to provide a method of protecting magnesium or magnesium alloys with a non-chromium conversion coating by contacting the magnesium or magnesium alloy with an aqueous solution containing as the essential ingredients, thereof, an alkali metal permanganate forming a protective conversion coating on the magnesium or magnesium alloy and removing any excess coating solution from the magnesium or magnesium alloy. The non-chromium containing alkali metal permanganate aqueous solution has a PH of between 2.5 and 4.0, and the alkali metal is selected from potassium, sodium or lithium. The alkali metal permanganate composition may be applied in any acceptable manner (i.e., immersion, spraying, misting or spreading by an appropriate applicator). The magnesium or magnesium alloy article is normally immersed in my aqueous solution with a permanganate concentration of about 0.076% to about 0.45% by weight permanganate ion and a preferred concentration of about 0.226% by weight. The temperature of the solution during the treatment of the magnesium or magnesium alloy is between 33° F. and 175° F. The upper concentration of the permanganate ion may be higher than the above-indicted limit of 0.45% but anything. over this amount is not economically practical. A saturated solution of permanganate ion is the upper limit of the concentration. For magnesium or magnesium alloys, especially cast magnesium and magnesium alloy, I utilize an acid composition of permanganate ions. The preferred permanganate is the alkali metal permanganate stated above. The composition is effective in protecting magnesium or magnesium alloys for more than 200 hours of salt-fog at 95° F. according to ASTM standard method B-117 on a conversion coated and/or paint primed surface. The process of coating the magnesium or magnesium alloy is generally carried out by cleaning the metal with an alkali metal hydroxide solution followed by treatment in a mild acid solution and then conversion coating with the permanganate ion solution. The preferred permanganate ion concentration is about 1.3 grams per liter to about 1.73 grams per liter with the minimum concentration recommended to provide 200 hours of protection being 0.760 grams per liter permanganate ion. The preferred temperature range is about 60° F. to 175° F. As the temperature is raised, less immersion time is necessary to form the corrosion resistant coating on the magnesium or magnesium alloy article. The most preferred temperature is 100° F. to about 175° F. The preferred PH range is about 2.5 to 4.0 with the most preferred PH being about 3.5 to about 4.0.

Other non-chromium compounds may be added to the permanganate solutions if desired, providing the compounds do not interfere with the desired corrosion resistant protection of the magnesium or magnesium alloy surfaces. The cleaning compounds for the magnesium or magnesium alloy surfaces are trichloroethane, sodium hydroxide, potassium hydroxide, alkaline solutions of sodium nitrate, hydrofluoric acid, acetic acid, citric acid, hydroxylacetic acid, nitric acid, sodium carbonate, borax, and a commercial non-ionic surfactant polyoxyethylene or polyoxypropylene derivatives of organic acids, alcohols, alkylphenols or amines. After cleaning the magnesium or magnesium alloy surfaces, the cleaned magnesium or magnesium alloy is rinsed in de-ionized water and then treated with the permanganate ion composition to conversion coat the surface of the metal.

The following examples illustrate specific embodiments of my invention and are not intended to limit the scope of my invention to the specific embodiments shown. Examples 3, 4, 6, and 8 test the limits of my compositions in terms of acidity, permanganate concentration and alkalinity respectively.

In the following examples all percentages are percentages by weight unless otherwise indicated. All magnesium and/or magnesium alloy panels were six inches by four inches and 0.032 inches thick.

### EXAMPLE 1

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was then immersed in a solution of 0.3% Potassium Permanganate and 1.0% Aluminum Nitrate Nine Hydrate as a buffer. The temperature of the solution was 70° F. and had a PH of 3.5. The panel was immersed for 90 seconds, removed from the solution, rinsed in de-ionized water and then dried. The dried panel was then primed with non-chromate containing polyamide primer, allowed to cure for seven days and placed in a neutral salt-fog spray at 95° F. according to ASTM specifications 117B. After 250 hours of exposure, the panel developed minor blistering and was removed.

### EXAMPLE 2

A pure magnesium panel is cleaned in a mild alkaline cleaner 140° F. for two minutes, rinsed in de-ionized water, deoxidized in a 5% citric acid solution for five minutes at 100° F and rinsed in de-ionized water for one minute. The magnesium panel was then immersed in a solution of 0.3% Potassium Permanganate and 1.0% Aluminum Nitrate Nine Hydrate as a buffer. The temperature of the solution was 70° F. and had a PH of 3.5. The panel was immersed for 90 seconds, removed from the solution, rinsed in de-ionized water and then dried. The dried panel was then primed with non-chromate containing alkyd primer, allowed to cure for seven days and placed in a neutral salt-fog spray at 95° F. according to ASTM specifications 117B. After 250 hours of exposure, the panel developed minor blistering and was removed.

### EXAMPLE 3

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was than immersed in a solution of 0.3% Potassium Permanganate and 0.1% Aluminum Nitrate Nine Hydrate as a buffer. The temperature of the solution was 70° F. and had a PH of 4.0. The panel was immersed for 90 seconds, removed from the solution, rinsed in de-ionized water and then dried. The dried panel was then primed with non-chromate containing polyamide primer, allowed to cure for seven days and placed in a neutral salt-fog spray at 95° F. according to ASTM specifications 117B. After 205 hours of exposure, the panel developed minor blistering and was removed.

### EXAMPLE 4

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was than immersed in a solution of 0.3% Potassium Permanganate and 10.0% Aluminum Nitrate Nine Hydrate as a buffer. The temperature of the solution was 70° F. and had a PH of 2.5. The panel was immersed for 90 seconds, removed from the solution, rinsed in de-ionized water and then dried. The dried panel was then primed with non-chromate containing polyamide primer, allowed to cure for seven days and placed in a neutral salt-fog spray at 95° F. according to ASTM specifications 117B. After 204 hours of exposure, the panel developed minor blistering and was removed.

### EXAMPLE 5

A magnesium alloy panel consisting of 96% magnesium, 3% Aluminum and 1% zinc (United States designation: AZ31B) was cleaned in a mild alkaline cleaner at 140° F. for two minutes, rinsed in de-ionized water, deoxidized in a 5% acetic acid solution containing 200 ppm fluoride for five minutes at 100° F. and rinsed in de-ionized water for one minute. The magnesium alloy panel was than immersed in a solution of 0.3% Potassium Permanganate and 1.0% Aluminum Nitrate Nine Hydrate as a buffer. The temperature of the solution was 70° F. and had a PH of 3.5. The panel was immersed for 90 seconds, removed from the solution, rinsed in de-ionized water and then dried. The dried panel was then primed with non-chromate containing polyamide primer, allowed to cure for seven days and placed in a neutral salt-fog spray at 95° F. according to ASTM specifications 117B. After 250 hours of exposure, the panel developed minor blistering and was removed.

### EXAMPLE 6

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was than immersed in a solution of 0.11% Potassium Permanganate and 1.0% Aluminum Nitrate Nine Hydrate as a buffer. The temperature of the solution was 70° F. and had a PH of 3.5. The panel was immersed for 90 seconds, removed from the solution, rinsed in de-ionized water and then dried. The dried panel was then primed with non-chromate containing polyamide primer, allowed to cure for seven days and placed in a neutral salt-fog spray at 95° F. according to ASTM specifications 117B. After 201 hours of exposure, the panel developed minor blistering and was removed.

### EXAMPLE 7

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was than immersed in a solution of 0.3% Potassium Permanganate and 1.0% Aluminum Chloride as a buffer. The temperature of the solution was 70° F. and had a PH of 3.5. The panel was immersed for 90 seconds, removed from the solution, rinsed in de-ionized water and then dried. The dried panel was then primed with non-chromate containing polyamide primer, allowed to cure for seven days and placed in a neutral salt-fog spray at 95° F. according to ASTM specifications 117B. After 250 hours of exposure, the panel developed minor blistering and was removed.

### EXAMPLE 8

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was than immersed in a solution of 0.3% Potassium Permanganate and 0.1% Aluminum Nitrate Nine Hydrate as a buffer. The temperature of the solution was 70° F. and had a PH of 4.0. The panel was immersed for 90 seconds, removed from the solution, rinsed in de-ionized water and then dried. The dried panel was then primed with non-chromate containing polyamide primer, allowed to cure for seven days and placed in a neutral salt-fog spray at 95° F. according to ASTM specifications 117B. After 203 hours of exposure, the panel developed minor blistering and was removed.

### EXAMPLE 9

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was than immersed in a solution of 0.3% Potassium Permanganate and 0.3% Phthalic acid based buffer. The temperature of the solution was 70° F. and had a PH of 3.0. The panel was immersed for 90 seconds, removed from the solution, rinsed in de-ionized water and then dried. The dried panel was then primed with non-chromate containing polyamide primer, allowed to cure for seven days and placed in a neutral salt-fog spray at 95° F. according to ASTM specifications 117B. After 250 hours of exposure, the panel developed minor blistering and was removed.

### EXAMPLE 10

A magnesium alloy panel consisting of 96% magnesium, 3% Aluminum and 1% zinc (United States designation: AZ31B) was cleaned in a mild alkaline cleaner at 140° F. for two minutes, rinsed in de-ionized water, deoxidized in a 0.1% nitric acid solution containing 200 ppm fluoride for five minutes at 100° F. and rinsed in de-ionized water for one minute. The magnesium alloy panel was than immersed in a solution of 0.3% Potassium Permanganate and 1.0% Aluminum Nitrate Nine Hydrate as a buffer. The temperature of the solution was 70° F. and had a PH of 3.5. The panel was immersed for 90 seconds, removed from the solution, rinsed in de-ionized water and then dried. The dried panel was then primed with non-chromate containing epoxy primer, allowed to cure for seven days and placed in a neutral salt-fog spray at 95° F. according to ASTM specifications 117B. After 250 hours of exposure, the panel developed minor blistering and was removed.

### EXAMPLE 11

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The cleaned magnesium panel was than immersed in a solution of 0.3% Potassium Permanganate and 1.0% Aluminum Nitrate Nine Hydrate as a buffer. The temperature of the solution was 70° F. had a PH of 3.5. The panel was immersed for 90 seconds, removed from the solution, rinsed in de-ionized water and then dried. The dried panel was then primed with non-chromate containing polyamide primer, allowed to cure for seven days and subjected to the standard “ASTM 3359-87” dry paint adhesion test. There was no loss of adhesion

### EXAMPLE 12

An “AZ31B” alloy magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was than immersed in a solution of 0.3% Potassium Permanganate and 1.0% Aluminum Nitrate Nine Hydrate as a buffer. The temperature of the solution was 70° F. and had a PH of 3.5. The panel was immersed for 90 seconds, removed from the solution, rinsed in de-ionized water and then dried. The dried panel was then primed with non chromate containing polyamide primer, allowed to cure for seven days and subjected to the standard “ASTM 3359-87” dry paint adhesion test. There was no loss of adhesion.

### EXAMPLE 13

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was than immersed in a solution of 0.3% Potassium Permanganate and 1.0% Aluminum Nitrate Nine Hydrate as a buffer. The temperature of the solution was 70° F. and had a PH of 3.5. The panel was immersed for 90 seconds, removed from the solution, rinsed in de-ionized water and placed in boiling D.I. water. The panel did not change in color and did not reduce the water with the slow release of hydrogen gas. After one hour the panel was removed.

### EXAMPLE 14

A pure magnesium panel is cleaned in a mild alkaline cleaner 140° F. for two minutes, rinsed in de-ionized water, deoxidized in a 5% hydroxylacetic acid solution for five minutes at 100° F. and rinsed in de-ionized water for one minute. The magnesium panel was then placed in boiling D.I. water. There was the slow release of hydrogen gas and the development of a thin film of magnesium oxides on the surface of the magnesium giving the panel a light golden color.

While this invention has been illustrated and described in the proceeding disclosure, it is recognized that variations and changes may be made, therein, without departing from the invention as set forth in the claims.

What is claimed is:

1. A method of coating a magnesium or magnesium alloy article with a non chromium oxide protective coating comprising:
coating a cleaned magnesium or magnesium alloy article with a permanganate composition having a PH of about 2.5 to about 4.0.

2. The method of claim 1, wherein said permanganate composition has a permanganate concentration of at least 0.760 gms per liter.

3. The method of claim 2, wherein the temperature of the permanganate composition is 60° F. to 175° F.

4. The method of claim 3, wherein the permanganate is an alkali metal permanganate with the alkali metal being selected from the group consisting of sodium, potassium, and lithium.

5. The method of claim 4, wherein the cleaned magnesium or magnesium alloy article is exposed to the permanganate composition for at least 45 seconds.

6. The method of claim 5, wherein the pH is 3.0 to 4.0; the concentration of the permanganate is greater than 1.3 gms per liter; the composition contains a buffer; and the coated surface is dried to provide a protected magnesium or magnesium alloy article that will pass the neutral salt-fog spray at 95° F. according to ASTM 117B specification for at least 200 hours exposure.

7. The method of claim 6, wherein the buffer is an aluminum salt.

8. The method of claim 7, wherein cleaned magnesium or magnesium alloy article is exposed to the permanganate composition for at least 90 seconds.

9. The method of claim 2, comprising the further steps of drying the permanganate coated magnesium or magnesium alloy article, and painting the dried permanganate magnesium or magnesium alloy article to provide a paint protected magnesium or magnesium alloy article that will pass the neutral salt-fog spray at 95° F. according to ASTM 117B specification for at least 200 hours exposure.

10. The method of claim 9, wherein the magnesium or magnesium alloy article is first cleaned with a mild alkaline cleaner and then deoxidized to provide said cleaned magnesium or magnesium alloy article and the permanganate composition contains a buffer.

11. The method of claim 2, wherein the temperature of the permanganate composition is 60° F. to 175° F.; the pH is 3.0 to 4.0; the concentration of the permanganate is greater than 1.3 gms per liter; the permanganate composition contains an aluminum salt buffer; the permanganate is an alkali metal permanganate with the alkali metal being selected from the group consisting of sodium, potassium, and lithium; the cleaned magnesium or magnesium alloy article is exposed to the permanganate composition for at least 90 seconds; drying the permanganate coated magnesium or magnesium alloy article; and painting the dried permanganate magnesium or magnesium alloy article to provide a paint protected magnesium or magnesium alloy article that will pass the standard ASTM 3359-87 dry paint adhesion test.

12. A magnesium or magnesium alloy article having coated thereon a permanganate composition that will allow the article to be painted with an appropriate paint.

13. The magnesium or magnesium alloy article of claim 12 wherein the permanganate composition was formed from an alkali metal permanganate with the alkali metal being selected from the group consisting of sodium, potassium and lithium.

14. The magnesium or magnesium alloy article of claim 13, wherein the article has a layer of an appropriate paint over the permanganate composition to provide a paint protected magnesium or magnesium alloy article that passes the neutral salt-fog spray at 95° F. according to ASTM 117B specification for at least 200 hours exposure.

15. The magnesium or magnesium alloy article of claim 12, wherein the permanganate composition has a pH is 3.0 to 4.0; a temperature of is 60° F to 175° F.; a permanganate ion concentration greater than 1.3 gms per liter; and a buffer;

16. The magnesium or magnesium alloy article of claim 15, wherein the permanganate composition was formed from an alkali metal permanganate with the alkali metal being selected from the group consisting of sodium, potassium and lithium.

17. The magnesium or magnesium alloy article claim 16, wherein the article has a layer of an appropriate paint over the permanganate composition to provide a paint protected magnesium or magnesium alloy article that passes the standard ASTM 3359-87 dry paint adhesion test.
